(19) United States
(12) Patent Application Publication
(10) Pub. No.: US 2014/0011625 A1
(43) Pub. Date: Jan. 9, 2014

(54) GEAR REDUCTION MECHANISM

(71) Applicant: Robert William Thompson, Camberley (GB)

(72) Inventor: Robert William Thompson, Camberley (GB)

(73) Assignee: QINETIQ LIMITED, Farnborough, Hampshire (UK)

(21) Appl. No.: 14/006,516

(22) PCT Filed: Mar. 21, 2012
(86) PCT No.: PCT/GB2012/000256

§ 371 Date: Sep. 20, 2013

(30) Foreign Application Priority Data
Mar. 24, 2011 (GB) 1104917.8

(51) Int. Cl. B62D 55/125; F16H 1/20

(52) U.S. Cl. CPC B62D 55/125; F16H 1/20
USPC 475/225; 74/664

(57) ABSTRACT

A gear reduction mechanism, particularly for use in an offset final drive unit for vehicular applications, has an input gear meshing directly with the output gear and two additional gear trains between the input and output gears. Three separate load paths therefore exist for the transmission of torque from the input gear to the output gear which means that the face widths of all the gears can be substantially reduced in comparison with a conventional single-mesh arrangement and the overall mechanism can therefore be of reduced width.

The present invention relates to gear reduction mechanisms where the input gear and the output gear turn on respective axes offset from each other. Such mechanisms may particularly (though not exclusively) be incorporated in final drive units for vehicular applications and especially final drives for tracked (and hence skid steered) vehicles. Even more particularly, the invention will be described hereinafter by way of example in terms of its application within an overall drive configuration for a battle tank, bulldozer or other skid steered vehicle of the kind described in WO-021083483 or WO-2006/021745. Offset final drive units according to the invention may also have application to wheeled vehicles, however, for example to allow for additional ground clearance, it being noted that final drives for wheeled vehicles are also known as “hub reduction” units.

Tracked vehicle drive systems often consist of a transmission mounted across the vehicle with drive shafts coupling to final drive units at each side. The final drive units generally comprise a casing carrying a bearing arrangement supporting a track drive sprocket around which the track at the respective side of the vehicle passes. The casing also includes a final gear reduction stage. An offset final drive will have its output to the track drive sprocket on a different axis to the input from the transmission. This may be necessary in some vehicle designs e.g. to position the axis of the track drive sprocket forward of the vehicle hull, below the axis of the input from the transmission, or otherwise offset. Known offset final drives therefore generally use a simple two spur gear set. This gear arrangement is generally large in volume and weight, however, since all of the power and torque must be transmitted through a single gear mesh. Also large bearings and a strong gear casing are required to support the reaction forces from the gear mesh. These problems can be avoided in final drives based on a planetary gear set but the latter are necessarily restricted to in-line arrangements where the output is coaxial with the input.

The gearing of an offset final drive must be sized to transmit the required torque and power with the desired input axis to output axis offset distance. This distance combined with the required gear reduction ratio determines the diameters of the gears used in the conventional two spur gear arrangement. The cross-sectional size of the gear teeth is determined by the desirable numbers of teeth on each gear. The only other parameter which can be selected to meet the required load capacity is the gear face width. For this reason the gears used in conventional offset final drives tend to have wide faces, typically in the order of 150 mm in the case of military tracked vehicles. In addition the bearings supporting the pinion (input gear) in such a final drive must normally be positioned on a shaft projecting from each side of the gear. The overall width of the final drive unit is therefore determined by these bearings and the gear face width. The final drives must fit between the respective track drive sprockets and the inboard transmission and so their width is critical in determining the width available inside the vehicle for the transmission. Overall vehicle width is often limited by requirements to fit inside transport aircraft and to maintain mobility in urban environments. Minimising final drive width can therefore be critical to the overall design of a vehicle.

In one aspect the present invention seeks to provide a gear reduction mechanism which may in particular be embodied in an offset vehicular final drive and which can combine a high load capacity with a limited width envelope and in this aspect accordingly resides in a gear reduction mechanism comprising an input gear, an output gear turning on an axis offset from that of the input gear, and a plurality of intermediate gears between the input gear and the output gear, all constructed and arranged such that there are at least three separate load paths for the transmission of torque from the input gear to the output gear.

In such an arrangement the totality of torque transmitted from the input gear to the output gear can be shared among the plural load paths. It follows that since each load path transmits only a fraction of the total torque then the face widths of the gears in all those paths can be substantially reduced in comparison with a conventional offset arrangement where the same total torque is transmitted through a single path, meaning that the overall mechanism can be of reduced width. The overall weight of the assembly can also be reduced as the input and output gears can be reduced to a fraction of their weight in a conventional offset arrangement with the addition of a set of relatively small intermediate gears.

In a preferred embodiment the input gear meshes directly with the output gear and the mechanism further comprises two separate gear trains between the input and output gears. More particularly each said gear train may comprise a first intermediate gear meshing separately with the input gear and a second intermediate gear meshing between a respective said first intermediate gear and the output gear. The input gear preferably meshes with the output gear and with said gear trains at respective positions substantially equi-spaced around its circumference.

In the foregoing embodiment, therefore, three separate load paths are defined between the input and output gears, one by the direct mesh between those gears and two more by the separate gear trains. Other embodiments can be envisaged, however, where there are four or even more load paths between the input and output gears and/or where each load path involves one or more intermediate gears.

Preferably, the input gear in a mechanism according to the invention is not constrained radially by a bearing and in use can float between the gears with which it meshes, so as to equalise the load in each of the paths.

Preferably also the output gear and intermediate gears are mounted on respective bearings which are accommodated within the width envelope of the respective gear teeth, so that these bearings do not add to the width of the overall mechanism, and where it is required to accommodate misalignments within the mechanism these bearings may be self-aligning (e.g. spherical roller) bearings.

In another embodiment the input gear is axially located by means of thrust components, preferably thrust cones, fixed to that gear and overlapping the edges of the gears with which it meshes.

The input gear may also be connected to be driven by a shaft through two successive crowned gear coupling in order to permit it to float between and align with the gears with which it meshes.

The invention also resides in a final drive unit comprising a gear reduction mechanism as defined above, and in such a unit the output gear of the gear reduction mechanism may be coupled to a shaft which turns a track drive sprocket or wheel hub. When misalignments need to be accommodated the output gear is preferably coupled to the shaft through a constant velocity, universal or crowned spline joint, and in such a case this joint is preferably centred on a common plane with the above-mentioned self-aligning bearings when fitted.

The invention also resides in a drive configuration for a skid steered vehicle comprising: a pair of propulsion motors coupled through respective transmissions to drive a respective drive member (such as a track drive sprocket in the case of a tracked vehicle or a wheel hub in the case of a wheeled vehicle) at a respective side of the vehicle; at least one steer motor coupled to a differential gear mechanism coupled between said propulsion motors to selectively impose a speed difference between said drive members; and each transmission comprising a respective final drive unit as defined above associated with the respective drive member.

The invention further resides in a vehicle equipped with a gear reduction mechanism, final drive units or a drive configuration as defined above.

The invention will now be more particularly described, by way of example, with reference to the accompanying drawings, in which:

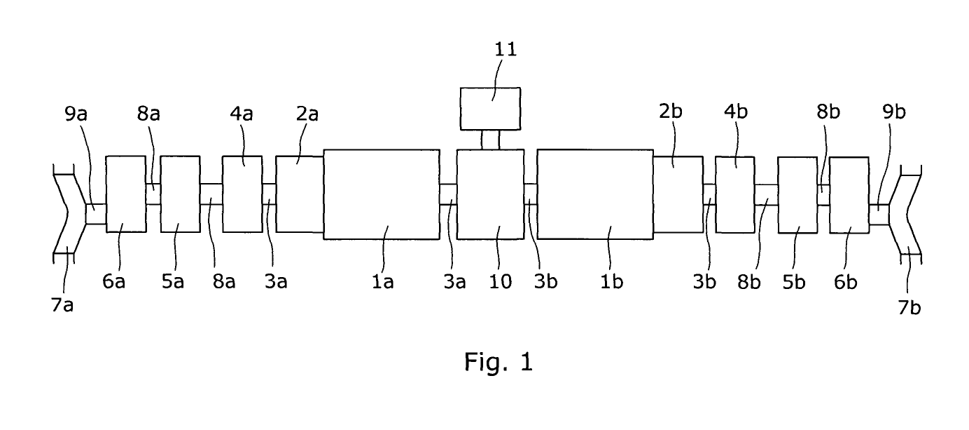

FIG. 1 is a diagrammatic illustration of a drive configuration for a skid steered vehicle in which the invention may be embodied;

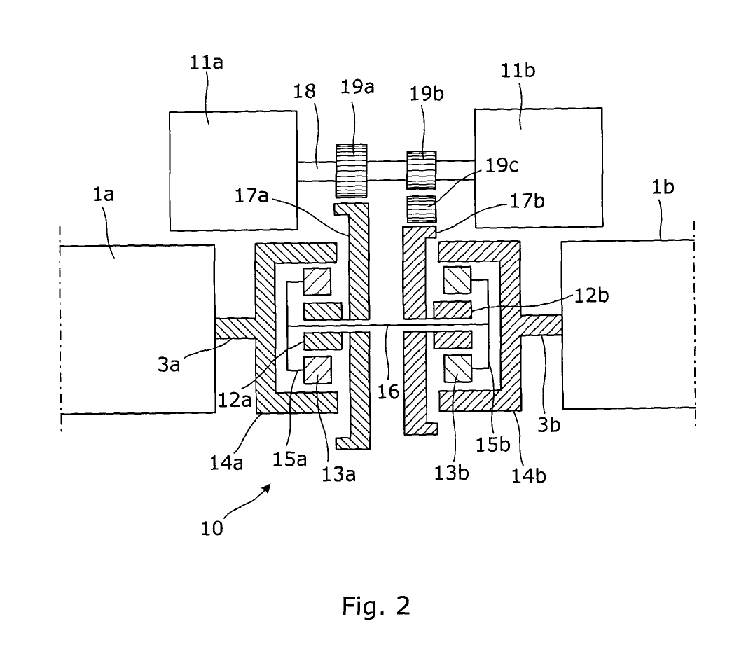

FIG. 2 illustrates schematically a mechanism for the controlled differential of the configuration of FIG. 1;

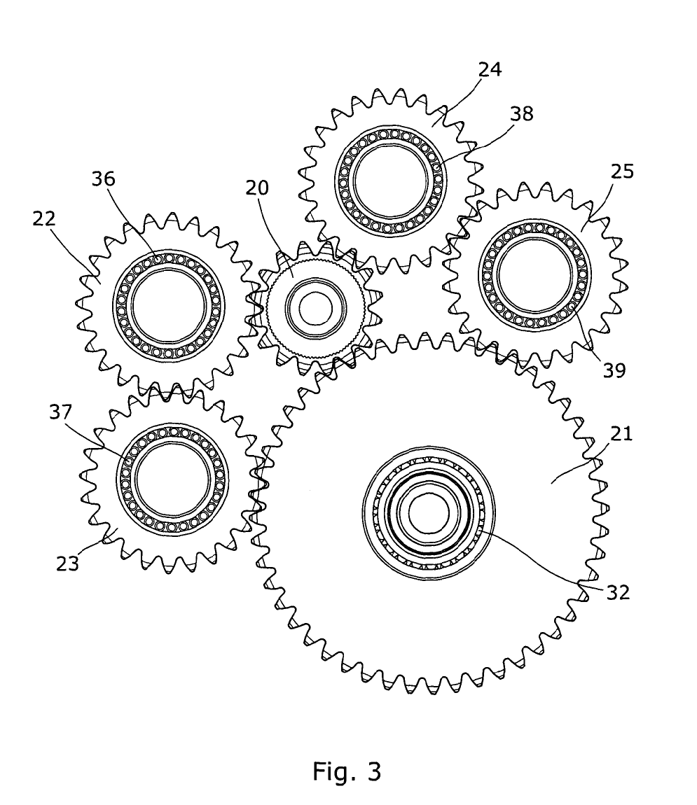

FIG. 3 illustrates the set of gears in a preferred embodiment of a gear reduction mechanism according to the invention;

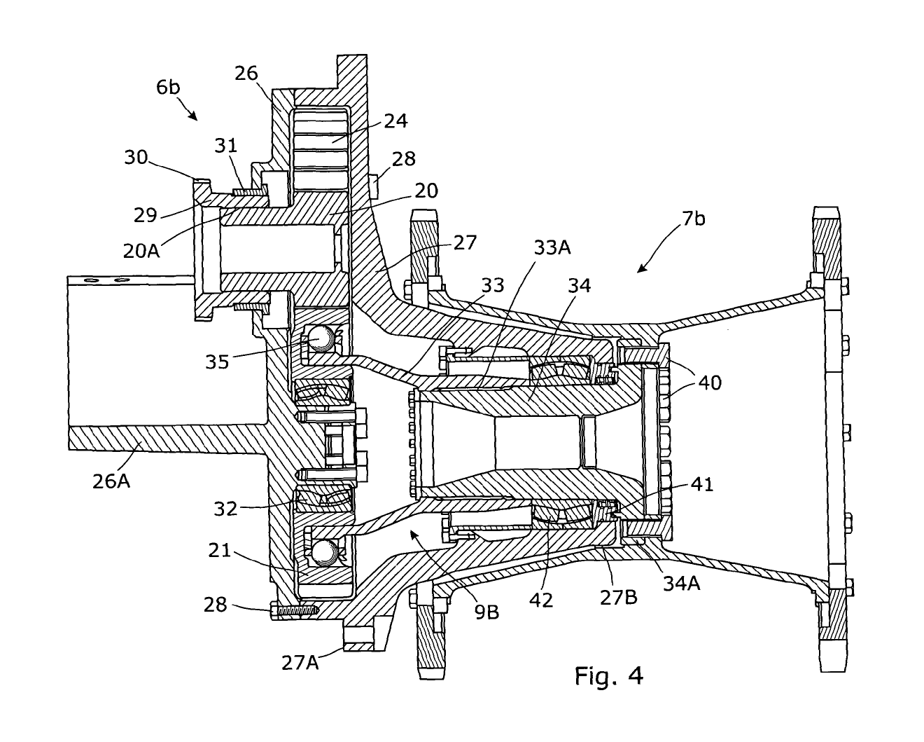

FIG. 4 is a cross-section through a preferred form of final drive unit incorporating the gear set of FIG. 3 and for use in the drive configuration of FIG. 1, taken in a plane including the axes of the input and output gears of FIG. 3;

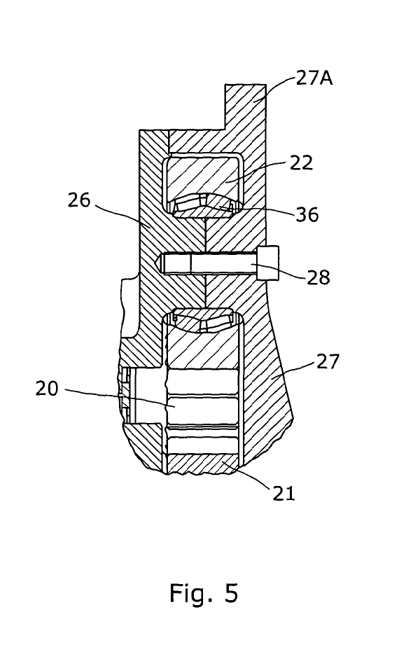

FIG. 5 is a scrap section through the unit of FIG. 4, taken in a plane offset from FIG. 4 and including the axis of one of the intermediate gears; and

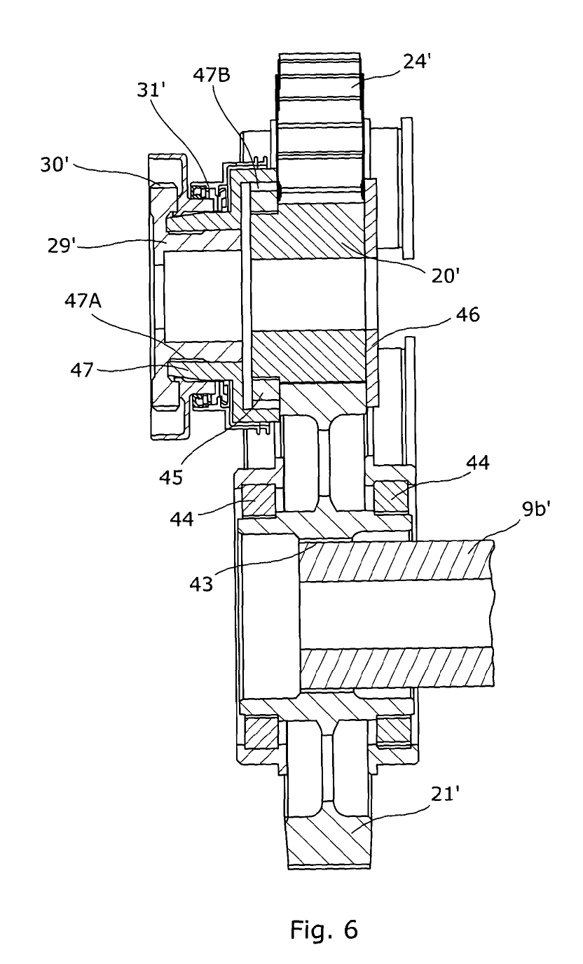

FIG. 6 is a cross-section through part of a modified form of the final drive unit of FIG. 4, taken in a plane including the axes of the input and output gears.

FIG. 1 illustrates diagrammatically one form of vehicular drive configuration with which final drive units in accordance with the present invention may be found particularly useful, being a track drive arrangement for a skid steered vehicle according to WO-02/083483 or WO-2006/021745. In this Figure a transverse drive arrangement comprises two electric propulsion motors 1a and 1b with associated gear change units 2a and 2b turning drive shafts 3a and 3b respectively. Outboard of these units the transmission includes in each case a gear reduction stage 4a, 4b, a brake 5a, 5b and a final drive gear reduction unit 6a, 6b, leading to respective track drive sprockets 7a, 7b at opposite sides of the vehicle. In this embodiment the final drives 6a, 6b are of offset design, having an input from the respective output shaft 8a, 8b from the respective gear reduction stage 4a, 4b (upon which shafts the respective brakes 5a, 5b also act), and an output through respective shafts 9a, 9b to the respective track drive sprockets 7a, 7b on an axis generally parallel to the shafts 8a, 8b.

Inboard the motors 1a, 1b are coupling through the shafts 3a, 3b to opposite sides of a controlled differential device 10 having an input from one or more electric steer motors 11.

The mechanism of one suitable form of differential 10 is illustrated schematically in FIG. 2. It comprises an opposed pair of planetary gear sets each comprising a sun gear 12a, 12b, planet gears 13a, 13b and an annulus or ring gear 14a, 14b, with the planet carriers 15a, 15b of each set interconnected by a cross shaft 16 passing through the sun gears. The annuli 14a, 14b are coupled to the respective adjacent drive shafts 3a, 3b and the sun gears 12a, 12b are fast with respective input gears 17a, 17b which can be driven when required in this case by a coupled pair of steer motors 11a, 11b. The steer motors are in this respect each coupled to a shaft 18 carrying a pinion 19a meshing with gear 17a, and a pinion 19b meshing through an idler gear 19c with gear 17b, so that the direction of rotation of the gear 17b in response to rotation of the shaft 18 is reversed as compared to the direction of rotation of the gear 17a.

During straight running of the vehicle the steer motors 11a, 11b are energised to hold the shaft 18 stationary, so the input gears 17a, 17b and sun gears 12a, 12b are likewise held stationary. Energising the propulsion motors la, lb to drive the sprockets 7a, 7b in this condition also rotates the annuli 14a, 14b to cause the planet gears 13a, 13b to revolve about the sun gears 12a, 12b. Due to their connection by the shaft 16 the two planet carriers 15a, 15b must rotate at the same speed, also equalising the speeds of the two annuli 14a, 14b and the two connected shafts 3a, 3b and related transmission trains in this condition. The actual power distribution between the two transmissions will be determined by the torque required to drive the respective sprockets 7a, 7b with torque being transferred through the controlled differential 10 from one side to the other as required e.g. in respect to changing ground conditions. To turn the vehicle in one sense while being propelled by the motors 1a, 1b as above the steer motors 11a, 11b are energised to rotate the shaft 18 in a corresponding sense, thus causing the input gears 17a, 17b and their respective sun gears 12a, 12b to rotate in mutually opposite senses. The effect, since the two planet carriers 15a, 15b must always turn together, is to increase the rate of rotation of the individual planet gears 13a, or 13b in that set for which the sun gear 12a or 12b is turning in the opposite sense to the respective annulus 14a or 14b, and to decrease the rate of rotation of the individual planet gears 13a or 13b in that set for which the sun gear 12a or 12b is turning in the same sense as the respective annulus 14a or 14b. This in turn causes the annuli 14a, 14b and respective connected transmissions to the sprockets 7a, 7b to run at different speeds thus turning the vehicle in the required sense, while power from the slower running transmission is mechanically regenerated to the faster running transmission through the controlled differential 10. To turn the vehicle in the opposite sense the steer motors 11a, 11b are energised to rotate the shaft 18 in the opposite sense and so forth, and it will be appreciated that for a given forward speed of the vehicle the turning radius in either sense will depend on the speed at which the steer motors are operated—the faster the steer motors the tighter the turn. In the limit, with zero forward speed the vehicle can be made to perform a neutral turn—i.e. “turning on the spot”—by driving the two transmissions in opposite directions through the differential 10. In a functionally equivalent arrangement one of the sun gears 12a or 12b can be permanently locked in place and a single gear train used from the shaft 18 to turn the other sun gear as required.

Turning now to FIG. 3 this shows the set of gears which is used to provide the gear reduction in accordance with the invention in each of the final drive units 6a, 6b. An input spur gear (pinion) 20 which is driven by the respective shaft 8a or 8b meshes directly with a larger output spur gear 21, on a generally parallel axis to that of gear 20, which drives the respective track drive sprocket 7a or 7b through the respective shaft 9a or 9b. In addition, two gear trains comprising a pair of intermediate spur gears 22, 23 and 24, 25 respectively are arranged between the gears 20 and 21 so that a total of three load paths exist between the gears 20 and 21 and each of the gears in the set can therefore be of narrower face width by a factor of three than in an arrangement in which the same load capacity must be met by a single mesh between input and output gears. Also the overall weight of the gear set can be significantly reduced since the input and output gears 20, 21 can be reduced to one third of the weight of their counterparts in a single mesh arrangement with the addition of only the relatively small intermediate gears 22-25.

The gears 21, 22 and 24 mesh with the gear 20 at respective positions substantially equi-spaced around its circumference, i.e. with substantially 120° angles between the three contact points. In addition the input gear is unconstrained radially by any bearing and free to float between the gears 21, 22 and 24, thereby equalising the distribution of load in each of the paths. All of the gears 20-25 have the same pressure angle so that the loads on the input gear 20 from the two intermediate gears 22, 24 and the output gear 21 will be symmetrical even though the output gear is larger than the intermediate gears.

FIG. 4 illustrates the overall final drive unit 6b, the unit 6a being equivalent and mounted in mirror image. It comprises a casing in two parts 26 and 27, held together by a series of bolts 28, which in the assembled vehicle is mounted through an aperture in the vehicle hull and secured by a series of bolts (not shown) passing through a flange 27A of the casing part 27. The casing part 26 also includes a cradle 26A which serves as one of the mounts for the inboard transmission. The input gear 20 is seen in this Figure together with the intermediate gear 24 and the output gear 21. The input gear 20 is splined at 20A to a coupling member 29 which terminates in a crowned gear 30 for coupling to the shaft 8b from the inboard transmission, the coupling between the shaft 8b and member 29 accommodating a certain degree of angular misalignment between the components as well as the float of the input gear 20. A sealing arrangement between the casing and member 29 is also notionally indicated at 31 which can accommodate the float of the input gear without loss of lubricant from within the unit.

The output gear 21 is mounted in the casing on a spherical roller bearing 32. Bearings of this nature allow a certain degree of tilt to be applied to the borne element. The output shaft 9b is formed in two parts 33 and 34 splined together at 33A and is coupled to the gear 21 through a so-called constant velocity (CV) joint comprising a ring of caged balls 35 through which torque is transferred and which allows for misalignment between the gear 21 and shaft 9b without change of velocity between those elements. The intermediate gears 22-25 are also mounted on respective spherical roller bearings, as indicated at 36-39 in FIG. 3 and seen for the gear 22 in FIG. 5. Each spherical roller bearing and the CV joint are centred on a common plane. This arrangement allows the output gear 21 and each of the intermediate gears 22-25 to self align with the input gear 20. Misalignment of the input shaft 8b due to assembly tolerance of the vehicle and vehicle flexibility can therefore be accommodated, and the amount of crowning that needs to be applied to the gears can be minimised which maximises gear strength. Also the self aligning nature of the bearings ensures accurate load sharing across the face of each gear even if the casing deflects due to loading from the vehicle's tracks or other dynamic vehicle inputs, thus further enhancing the strength and durability of the gears and reducing the need for a stiff gear casing which reduces the mass of the assembly.

Each bearing 32, 36-39 and the CV joint is accommodated within the width envelope of the respective gear teeth and their presence accordingly does not add to the overall width of the assembly. The absence of any bearing for the input gear 20—which conventionally would be located outside its width envelope due to the relatively small diameter of that gear—also assists in minimising the width of the assembly.

The track drive sprocket 7b is attached by a ring of bolts 40 to a flange 34A at the outer end of the shaft 9b, and an adjacent sealing arrangement 41 seals that end of the unit against loss of lubricant. This shaft is mounted on a spherical roller bearing 42 in the casing, which is located close to the centre line of the track to minimise any moment loads on the shaft. Small moment loads can be reacted through the CV joint at the other end of the shaft. Large moment loads, which can occur when the track hits obstacles, can be reacted by the sprocket 7b and shaft 9b deflecting until the inner edge of the sprocket contacts the outside edge of the casing at 27B.

Alternatives to the described CV joint would be a universal or crowned spline joint.

FIG. 6 illustrates part of a modified form of the above-described final drive unit where similar components to those of FIGS. 3-5 are denoted by the same reference numerals with the addition of a prime.

This embodiment is simplified by omission of the CV joint and instead there is a crowned spline coupling 43 between the output gear 21′ and output shaft 9b′. Also the four intermediate gears (of which one, 24′, is seen in FIG. 6) and the output gear 21′ are mounted on fixed, cylindrical roller bearings (of which the bearings 44 for the output gear are seen in FIG. 6) instead of spherical roller bearings. As before, the input gear 20′ is unconstrained radially by any bearing and free to float between its meshing gears, but in this case is axially located by the use of so-called thrust cones 45 and 46 fastened at each axial end of the gear. These components have flanges which overlap the edges of the three gears with which the input gear meshes, as is seen for gears 21′ and 24′ in FIG. 6. The thrust cones have a slightly conical surface where they overlap the other gears and engage with a toroidal or radiused edge on the latter.

As before, the input gear is connected to a coupling member 29′ which terminates in a crowned gear 30′ for coupling to the shaft from the inboard transmission, and a sealing arrangement is seen at 31′. In this case, however, there is a second coupling member 47 between the input gear and member 29′ which is splined to the member 29′ at 47A and connected to the thrust cone 45 of the input gear through a crowned gear coupling at 47B. The input gear 20′ is therefore free to angularly align itself with the fixed-axis output and intermediate gears and to float radially for load sharing, without the need for the spherical roller bearings and CV joint of the previous embodiment to allow the gear set to align to the input shaft.

The thrust cones 45 and 46 are fitted tightly to the sides of the meshing gears to provide angular location of the input gear to resist overturning moments from the crowned gear coupling between the coupling member 29′ and input shaft.

The teeth of the input gear 20′ are themselves provided with a small amount of crowning to accommodate small misalignments between the fixed-axis intermediate and output gears.

1. A gear reduction mechanism comprising an input gear, an output gear turning on an axis offset from that of the input gear, and a plurality of intermediate gears between the input gear and the output gear, all constructed and arranged such that there are at least three separate load paths for the transmission of torque from the input gear to the output gear.

2. A mechanism according to claim 1 wherein the input gear meshes directly with the output gear and further comprising two separate gear trains between the input and output gears.

3. A mechanism according to claim 2 wherein each said gear train comprises a first intermediate gear meshing separately with the input gear and a second intermediate gear meshing between a respective said first intermediate gear and the output gear.

4. A mechanism according to claim 2 wherein the input gear meshes with the output gear and with said gear trains at respective positions substantially equi spaced around its circumference.

5. A mechanism according to claim 1 wherein the input gear is not constrained radially by a bearing and in use can float between the gears with which it meshes.

6. A mechanism according to claim 1 wherein the output gear and intermediate gears are mounted on respective bearings which are accommodated within the width envelope of the respective gear teeth.

7. A mechanism according to claim 1 wherein the output gear and intermediate gears are mounted on respective self-aligning bearings.

8. A mechanism according to claim 7 wherein said bearings are spherical roller bearings.

9. A mechanism according to claim 1 wherein the input gear is axially located by means of thrust components fixed to that gear and overlapping the edges of the gears with which it meshes.

10. A mechanism according to claim 9 wherein said components are thrust cones.

11. A mechanism according to claim 9 wherein said input gear is connected to be driven by a shaft through two successive crowned gear couplings.

12. A final drive unit comprising a gear reduction mechanism according to claim 1.

13. A unit according to claim 12 wherein the output gear of the gear reduction mechanism is coupled to a shaft which turns a track drive sprocket or wheel hub.

14. A unit according to claim 13 wherein said output gear is coupled to said shaft through a constant velocity, universal or crowned spline joint.

15. A unit according to claim 14 wherein the output gear and intermediate gears are mounted on respective self-aligning bearings and said bearings and joint are centred on a common plane.

16. A drive configuration for a skid steered vehicle comprising: a pair of propulsion motors coupled through respective transmissions to drive a respective drive member at a respective side of the vehicle; at least one steer motor coupled to a differential gear mechanism coupled between said drive members; and each transmission comprising a respective final drive unit according to claim 12 associated with the respective drive member.

17. (canceled)

18. A vehicle equipped with a gear reduction mechanism, final drive units or a drive configuration according to claim 1.
